(19) United States
(12) Patent Application Publication
(10) Pub. No.: US 2010/0301626 A1
(43) Pub. Date: Dec. 2, 2010

(54) Cargo cage for an automobile

(76) Inventors: Brentwood Prescott Reid, Homer, AK (US); Tyler James Reid, Tuscumbia, AL (US)

Correspondence Address: Brentwood Reid, PO Box 2461, Homer, AK, 99603, US

(21) Appl. No.: 11/789,534

(22) Filed: Apr. 25, 2007

(51) Int. Cl. B60R 5/00

(52) U.S. Cl. 296/37.16

(57) ABSTRACT

The present invention provides the means to encage the rear cargo area of a hatch back automobile with a freestanding cage that attaches to the vehicle to at cargo tie down points manufactured into the vehicle to provide security for the cargo area even with the rear seat laid forward and the hatch open. The cage is comprised of a pair of horizontal floor frames (18), a forward frame (30) that runs parallel to the rear seat (12), a horizontal top frame (9) that is formed to the shape of the cargo compartment and is hinged in the center (16) parallel to the fender walls (20) so it may be folded in half to ease assembly and storage, and a pair or rear frames (22) that run parallel to the hatch (38) and span the length of the hatch opening when joined together by a locking mechanism (26). The rear frames (22) are hinged (24) at the opposite ends of the locking mechanism (26). The forward frame (30) and rear frames attaches (22) to the floor frames (18) and the upper frame (9) by means of clasps (25) that can only be accessed from within the cage. The upper frame (9), forward frame (30), and rear frames (22) are covered with a grating material (28). The cage attaches to the floor of the cargo area at cargo tie down points (34) manufactured into the vehicle by means of clasps or tabs (32) providing a free standing cage that is secured to the vehicle and cannot be easily removed or opened by unauthorized persons even with the hatch open and the rear seat folded forward. This has the added advantage of allowing the rear seat to be laid forward for the purpose of carrying more cargo while maintaining a secure cargo area.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF INVENTION

1. Field of Invention

This invention relates to security enclosures for the rear cargo compartment of a hatch back automobile.

2. Background of Invention

Most hatch back automobiles such as station wagons, mini vans, and sport utility vehicles are designed to be able to carry passengers comfortably and to be able to carry cargo of lengths and sizes that are not able to fit in the trunk space of a sedan type automobile. This is making them increasingly popular with business people, outdoors enthusiasts, and families with children. Many compact automobiles are also designed with hatch backs, and with the trend toward smaller, more economical automobiles trunk space is being replaced with small hatch back cargo areas to reduce the overall size of the vehicle. To cater to the higher end automobile market manufacturers are building many luxury vehicles with hatchbacks.

For the utility the hatch back design gains it sacrifices security. The cargo area in a hatch back automobile is usually defined by the rear seat, the rear fender walls, and the rear hatch leaving the cargo space open on top which would leave the cargo exposed and visible to passerbys. Unlike the locked trunk on a sedan type vehicle the cargo area of the hatchback could be accessed simply by breaking a window.

Prior art has attempted to prevent this with a number of cargo compartment covers and shades to block the cargo form view. However, these covers are easily movable or flimsy and easily removed through an open window and they offer no security when the rear seats are laid forward. Other prior art attempts to solve the problem with a rigid shelf held up on legs that attach to the floor or the side walls of the cargo compartment and rely on the rear seat and the hatch to remained closed to keep the cargo area secure. More and more vehicles are being designed with the means to open the hatch from the passenger compartment allowing thieves to open the hatch and access the cargo area by breaking a passenger compartment window and triggering the hatch. The rear seats can often be easily laid forward giving even more access to thieves. Prior art has attempted to solve this problem with latch locks for the rear seat and a number of permanent, removable, and/or collapsible boxes. Many of these boxes must be attached to the vehicle by altering the vehicle with hardware. Other boxes with solid floors must be removed to access any storage compartment recessed under the vehicles rear floorboard, which often includes tools and spare tire. Much of this prior art is limited in design and does not conform to the shape of the cargo area and fails to integrate aesthetically with the vehicle, which may be deemed unacceptable in luxury vehicles.

Security is a top concern of many automobile owners, especially those living and working in high density, urban areas. A habit that most urban dwellers have adopted is to never leave valuable articles in a parked automobile. This is certainly a wise habit to practice, but it can sometimes be a great inconvenience especially for salespersons or others who regularly carry a large amount gear in their automobiles and are unable to remove it from the vehicle during a business meeting or luncheon for example. What is needed is a way to secure the cargo area from not only “smash and grab” attacks, but also from thieves who are sophisticated enough to open the rear hatch or lower the rear seat.

### OBJECTS AND ADVANTAGES

The present invention provides the means to encage the rear cargo area of a hatch back automobile with a freestanding cage that attaches to the vehicle to provide security for the cargo area. The cage attaches to the vehicle at points manufactured into the rear cargo area and does not require modifications to the vehicle. The cage is not dependent on the rear seat and provides security even with the rear seat laid forward and the hatch open. When unlocked, the rear frames of the cage can swing open like ambulance doors allowing cargo to be loaded and unloaded easily, and as the top of the cage is level with the top of the rear seat it makes full use of the cargo are.

The cage has the further advantage of allowing gear that does not fit inside the cage to be stacked on top of the cage as it provides a rigid shelf capable of withstanding a heavy load. This has a further advantage of allowing access to gear inside the cage without disturbing gear on top of the cage.

A further advantage of the cage is that it has an open floor so it does not restrict access to storage areas recessed in the floorboard of the cargo area allowing access, for example, to tools and spare tire without necessitating the removal of the cage from the vehicle.

The cage has the advantage of being collapsible, is able to be assembled and disassembled quickly and with little effort, and takes up little space when stored in the rear cargo area.

The design of the cage and materials from which it is manufactured are aesthetically pleasing and integrate well with the vehicle. The materials of which the cage is made are rigid enough to resist prying tools and to slow the progress of cutting tools. To further add to the aesthetics and the security of the cargo area the cage may be covered with carpet or with shades as seen in prior art.

These and other objects, features, and advantages of the present invention will become apparent from a reading of the following detailed description with references to the accompanying drawings.

### SUMMARY

A freestanding, semi-enclosed cage fitted to the cargo area of a hatchback automobile. The cage is attached to the floor of the rear cargo compartment at cargo tie down points manufactured into the vehicle forming a secure cage with the vehicle rear fender walls and cargo compartment floorboard acting as the walls and floor of the cage providing a secure cargo area even with the rear seat laid forward and hatch open.

### DRAWINGS

### Figures

The accompanying drawings are representative of a specific model of automobile. On other models only the size and shape of the elements would vary from those depicted in the accompanying drawings in which:

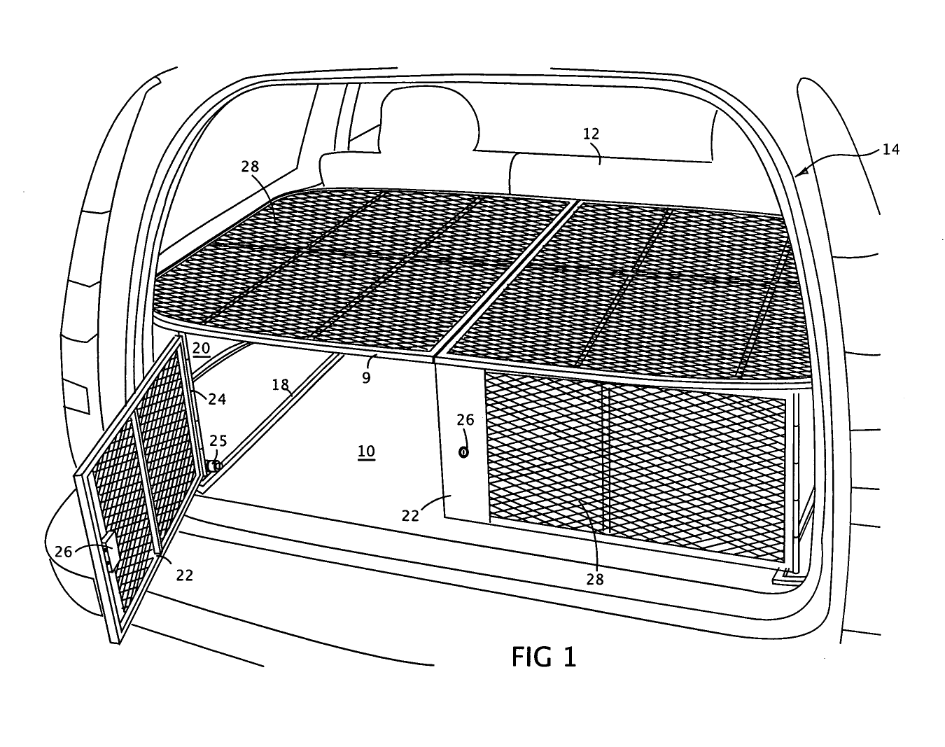

FIG. 1 is a representation of invention installed in the rear cargo area of a hatch back automobile.

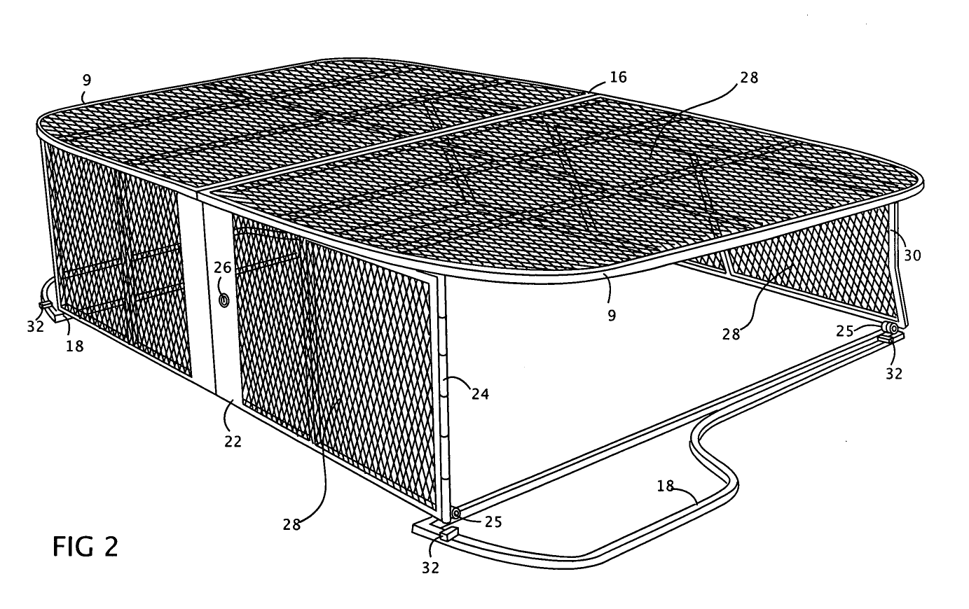

FIG. 2 is a perspective drawing of assembled invention from the rear view.

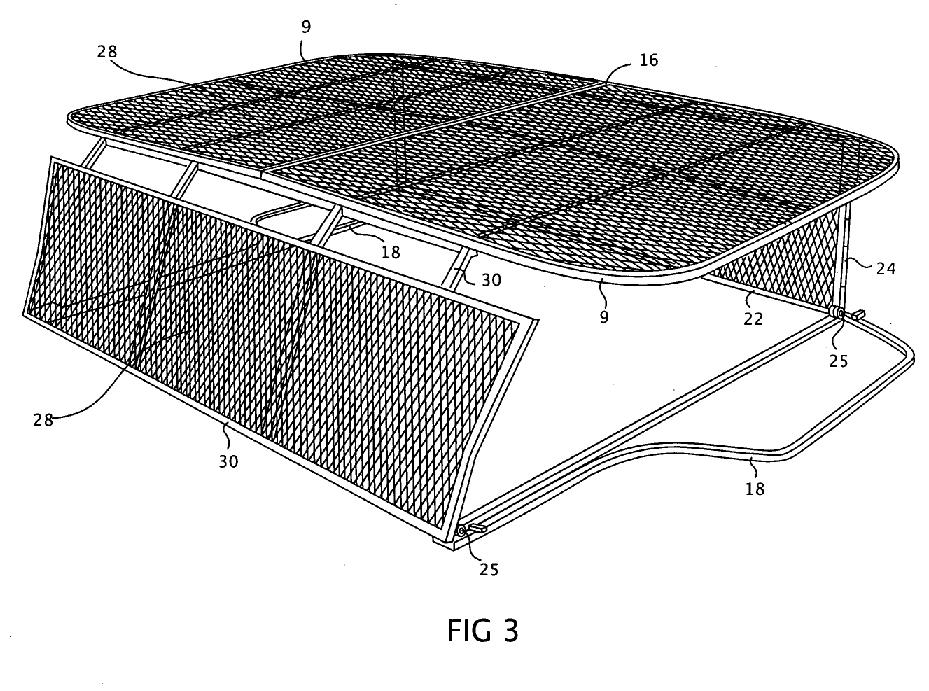

FIG. 3 is a perspective drawing of assembled invention from a forward view.

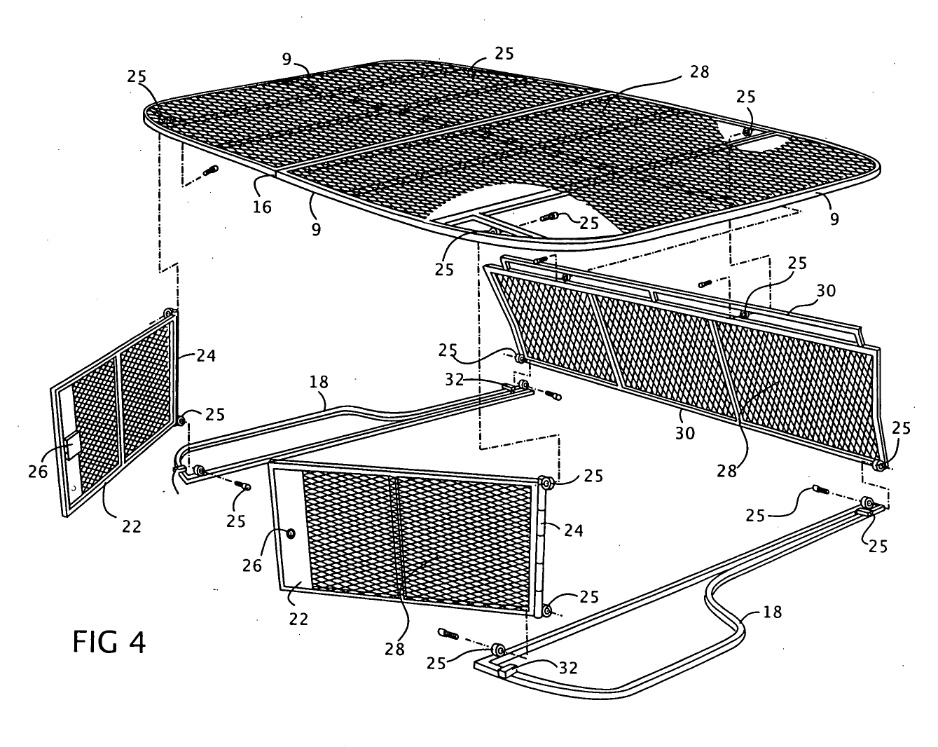

FIG. 4 is an exploded view of the invention.

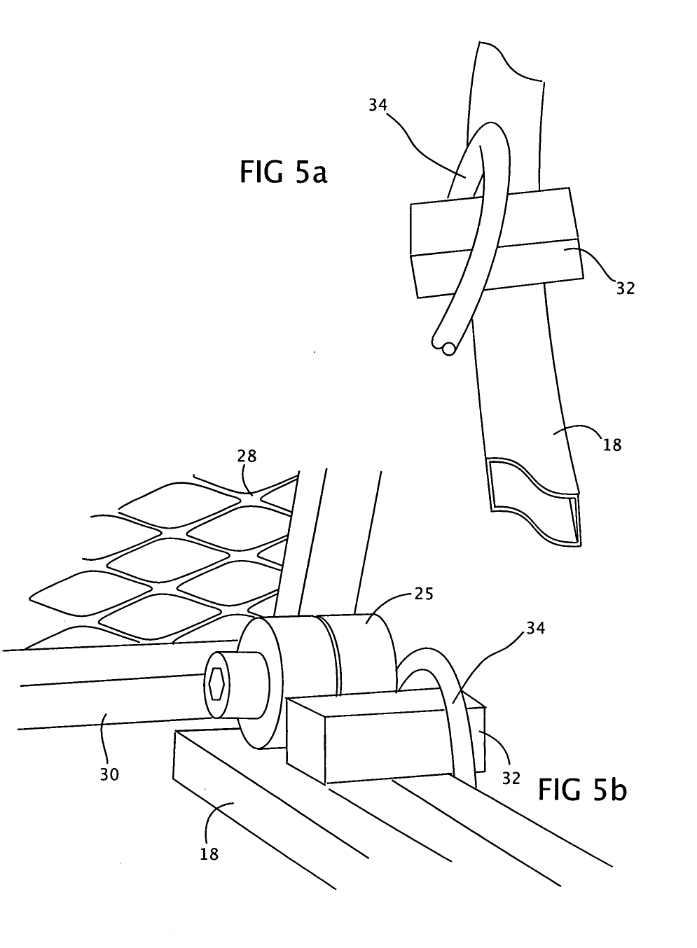

FIG. 5a is an example of a tab and tie down point.

FIG. 5b is an example of a tab and tie down point.

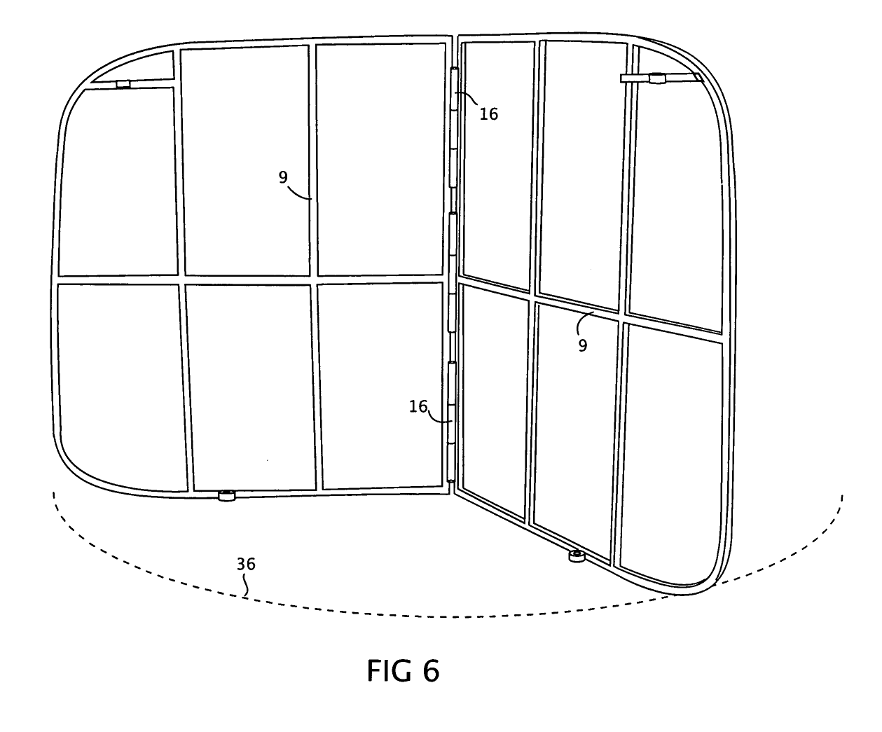

FIG. 6 is a drawing of the range of motion of upper frame.

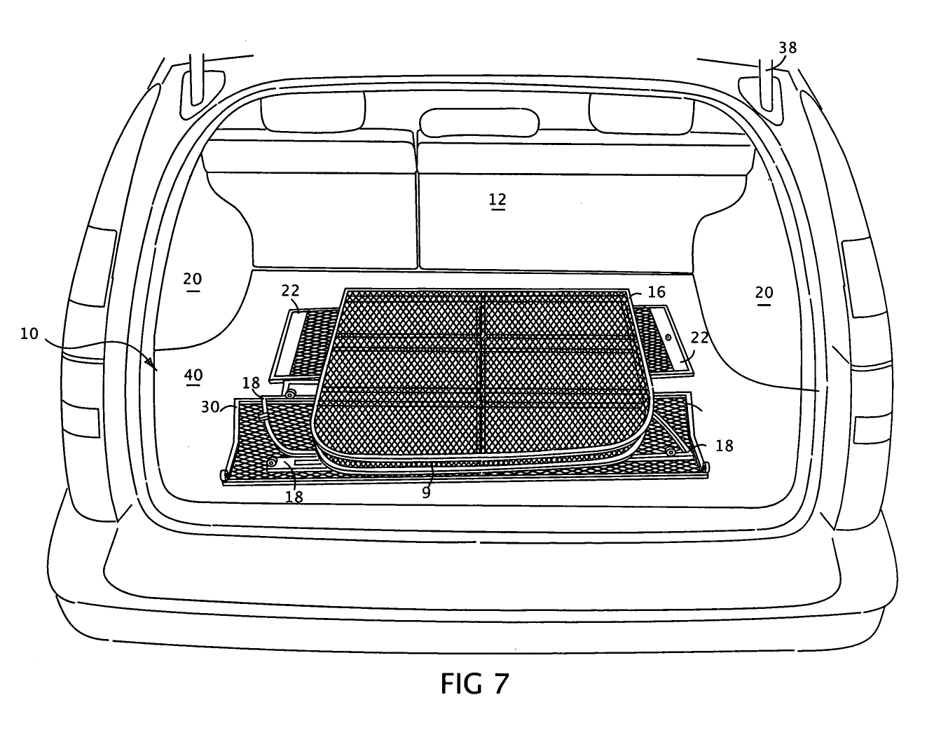

FIG. 7 is a drawing of the invention disassembled and stored in rear cargo area.

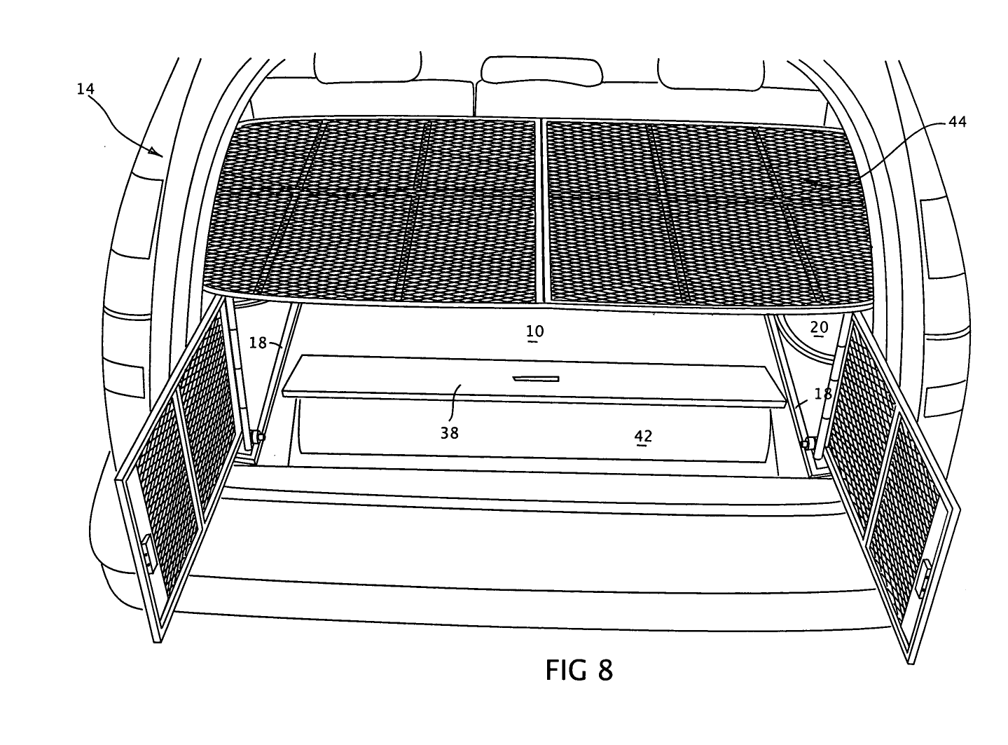

FIG. 8 is a drawing of floorboard storage access while invention is installed.

### DRAWINGS

### Reference Numerals

| | | | |
|---|---|---|---|
| 9 | upper frame | 10 | rear cargo area |
| 12 | rear seat | 14 | hatchback automobile |
| 16 | hinge | 18 | lower frame |
| 20 | cargo area side walls | 21 | rear frame in open position |
| 22 | rear frame | 23 | rear frame in closed position |
| 24 | hinge | 25 | clasp |
| 26 | lock mechanism | 28 | grating material |
| 30 | forward frame | 32 | tie down tab |
| 34 | tie down point | 36 | upper frame range of motion |

### DETAILED DESCRIPTIONS

### FIGS. 2,3,4,6

FIG. 2 is a perspective drawing of assembled invention from a rear view where: upper frame 9 is positioned horizontally and hinged in the center 16 to allow for rotational movement as seen in FIG. 6. Floor frames 18 are positioned horizontally and attach to forward frames 30 and rear frames 22 by means of clasps 25. The clasps 25 can of any number of quick release clasps with the limitation that it is not able to be released with a prying tool through the grating material 28. Tie down tabs 32 are placed at appropriate points along the floor frames 18 so that they interface with tie down points manufactured into the vehicle as seen in FIGS. 5a and 5b. Forward frame 30 is set approximately perpendicular to upper frame 9 and floor frames 18. Rear frames 22 are set approximately perpendicular to upper frame 9 and floor frames 18. The rear frames 22 are hinged at one end 24 for rotational movement and have a locking mechanism 26 at the other end to lock rear frames 22 in a closed position 23. Upper frame 9, forward frame 30, and rear frames 22 are covered with a grating material 28. A preferred embodiment of invention is made of steel tubing and expanded metal with a powder coated finish but may also be made of other materials such as aluminum, perforated steel, or extruded plastic for example. The materials are rigid enough to resist prying tools and to slow the progress of cutting tools.

FIG. 3 is a perspective drawing of invention from a forward position where: upper frame 9 is positioned horizontally and hinged in the center 16 to allow for rotational movement as seen in FIG. 6. Floor frames 18 are positioned horizontally and attach to forward frames 30 and rear frames 22 by means of clasps 25. Tie down tabs 32 are placed at appropriate points along the floor frames 18. Forward frame 30 is set approximately perpendicular to upper frame 9 and floor frames 18. Rear frames 22 are set approximately perpendicular to upper frame 9 and floor frames 18. Upper frame 9, forward frame 30, and rear frames 22 are covered with a grating material 28.

FIG. 4 is an exploded view of invention where: upper frame 9 is hinged in the center 16 perpendicular to forward frame 30 and attaches to forward frame 30 and rear frames 22 by means of clasps 25. Floor frames 18 are set horizontally and attach to forward frame 30 and rear frames 22 by means of clasps 25. Rear frames 22 are set approximately vertical and are hinged at one end 24 to allow for rotational motion and have a locking mechanism 26 at the other end. Tie down tabs 32 are set at appropriate points along the floor frames 18 to interface with tie down points manufactured into the vehicle as seen in FIGS. 5a and 5b. Upper frame 9, forward frame 30, and rear frames 22 are covered with a grating material 28.

FIG. 6 is a drawing of the range of motion of upper frame where upper frame 9 is hinged in the center 16 for rotational motion 36 to ease with assembly and storage.

Operation—FIGS. 1,5a,5b,7,8

FIG. 1 is a perspective view of the invention installed in the rear cargo area of a hatchback automobile where as: upper frame 9 is fitted to rear cargo area 10 at approximately the height of the top of rear seat 12 and is hinged 16 in the center to allow for ease in assemblage and storage. The height of upper frame 10 will vary from model to model depending on the relationship between rear seat 12 and rear side walls 20. The floor frames 18 are fitted to the shape of the rear side walls 20 and run the length of rear cargo area 10 to ensure a snug, stable fit. The rear frames 22 are hinged 24 at one end to allow for rotational movement between an open position 21 and closed position 23 and have a locking mechanism 26 at the other end to lock rear frames 18 in a closed position 23. This allows the rear frames 22 to behave like ambulance doors for ease in loading and unloading cargo, and to form a rigid wall in the closed position 23. Rear frames 22 are attached to upper frame 9 and lower frames 18 by a clasp 25 accessible only from within the cage. Upper frames 9 and rear frames 22 are covered with a grating material 28. The cage is installed in the automobile rear cargo area by first placing the floor frames 18 into position, making sure that tie down tabs 32 interface with tie down points as seen in FIGS. 5a and 5b. Next the forward frame 30 is set in place and attached to floor frames 18 by means of clasps 25. Next, rear frames 22 are set in place in the close position 21 and attached to floor frames 18 by means of clasps 25. Finally, upper frame 9 is folded at hinge 16 enough to fit through hatch opening then is unfolded and set in place. Rear frames 22 must now be opened to allow upper frame 9 to be attached by clasps 25.

FIG. 5a is an example of a tie down tab and a tie down point where: tie down tab 32 is attached to floor frame 18 at a point where it interfaces with tie down point 34 manufactured into the automobile. The placement of tabs will vary from model to model depending on the placement of the tie down points by the manufacturer. FIG. 5b is an example of a tie down tab and a tie down point where: forward frame 30 is attached to floor frame 18 by means of a clasp 25. Forward frame 30 is covered with a grating material 28. Tie down tab 32 is attached to floor frame 18 at a point where it interfaces with tie down point 34 manufactured into the automobile.

FIG. 7 is a drawing of the cage disassembled and stored in rear cargo area of a hatch back automobile where: rear cargo area 10 is defined by rear seat 12, rear side walls 20, hatch back 38, and rear floor 40. Upper frame 9 is hinged in the center 16 so as to fold in half for storage. Rear frames 22, floor frames 18 and forward frame 30 stack tightly together with upper frame 9 to occupy a minimal amount of space when disassembled and stored. This may be necessary to carry long, oversized cargo. It may at times only be necessary to disassemble the upper frame 9 and rear frames 22 while leaving the floor frames 18 and forward frame 30 in place.

FIG. 8 is a drawing of floorboard storage access while cage is installed where: the cage 44 is installed in rear cargo area 10 of a hatch back automobile 14. The floor frames 18 are fitted to rear side walls 20 of hatch back automobile 14 and are spaced wide enough to allow access to the floorboard storage area 42 by allowing floorboard storage area door 38 to open while invention is installed. This allows access to tools and spare tire without necessitating the removal of the cage.

### CONCLUSIONS, RAMIFICATIONS, AND SCOPE

Accordingly, the reader will see that the presented invention effectively provides a simple, easy to use devise for protecting valuables in the rear cargo area of a hatch back automobile. The invention can be assembled and disassembled very quickly and with little effort. Furthermore, as the cage takes up very little space when assembled, doesn't restrict access to tools and spare tire recessed in rear floorboard, and as it has been designed to integrate aesthetically with the vehicle there is little need to disassemble the device unless it is necessary to carry long, oversized cargo. In addition, as no vehicle modifications are required the cage does not

We claim:

1. A free standing cage for securing the rear cargo area of an automobile having a hatchback and cargo tie down points manufactured into said cargo area, the cage comprising:
(a) a horizontal upper frame fitted to the shape of said cargo area at approximately the height of the top of the rear seat comprising two identical frames joined by a hinge perpendicular to said rear seat,
(b) two horizontal floor frames that run adjacent and parallel to the fender walls of said cargo area and are shaped to said fender walls and span the depth of said cargo area and include means to attach said floor frames to said automobile at said tie down points manufactured into said automobile,
(c) an approximately vertical forward frame that runs adjacent and parallel to the rear seat of said automobile and spans the width of said cargo area and approximately the height of said rear seat,
(d) two vertical rear frames that are hinged at the ends for pivotal movement between an opened and a closed position and run adjacent and parallel to said hatchback and span approximately the height of said rear seat and span the length of the opening of said hatchback when joined together by a locking mechanism,
(e) said locking mechanism to join and lock said rear frames while in a closed position,
(f) means accessible only from within said cage to attach said upper frame to said forward and rear frames at points where said upper frame intersects said forward and rear frames,
(g) means accessible only from within said cage to attach said floor frames to said forward and rear frames at points where said floor frames intersect said forward and rear frames, and
(h) a grating material to cover said upper frame, said forward frame, and said rear frames.

2. A free standing cage from claim 1 wherein said floor frames are spaced so as not to cover a storage compartment recessed in said floor of said cargo area and impede the opening of the cover of said storage compartment.

3. A free standing cage from claim 1 wherein said means only accessible from within said cage to attach said upper frame to said forward and rear frames at points where said upper frame intersects said forward and rear frames and said means only accessible from within said cage to attach said floor frames to said forward and rear frames at points where said floor frames intersect said forward and rear frames is a quick release clasp.

4. A free standing cage from claim 3 wherein:
a) said upper frame can be quickly unattached from said forward and rear frames and folded in half and stored in said rear cargo area,
b) said forward and rear frames can be quickly unattached from said floor frames and stored with said folded upper frame to occupy a minimal amount of space in said rear cargo area.
